(19) United States
(12) Patent Application Publication
(10) Pub. No.: US 2026/0048637 A1
(43) Pub. Date: Feb. 19, 2026

(54) COOLANT SYSTEM FOR AN ELECTRIC OR HYBRID VEHICLE, AND THERMAL MANAGEMENT SYSTEM

(71) Applicant: HELLA GmbH & Co. KGaA, Lippstadt (DE)

(72) Inventor: Sebastian TIEMEYER, Dortmund (DE)

(73) Assignee: HELLA GmbH & Co. KGaA, Lippstadt (DE)

(21) Appl. No.: 19/371,011

(22) Filed: Oct. 28, 2025

Related U.S. Application Data
(63) Continuation of application No. PCT/EP2024/056675, filed on Mar. 13, 2024.

(30) Foreign Application Priority Data
Apr. 28, 2023 (DE) 10 2023 111 091.8

(51) Int. Cl. B60H 1/00

(52) U.S. Cl. CPC B60H 1/00571; B60H 1/00392; B60H 1/004

(57) ABSTRACT

A coolant system for circulating a coolant for an electric or hybrid vehicle, having a first coolant path with at least one first component to be cooled and/or to be heated, a second coolant path with at least one second component to be cooled and/or to be heated, and a third coolant path with a coolant/refrigerant heat exchanger for transmitting heat between the coolant system and a refrigerant system of the vehicle. An air/coolant heat exchanger transmits heat between the coolant and ambient air in a free environment. A valve system for realizing a plurality of coolant system states of the coolant system. The first coolant path with the aforementioned first component and the third coolant path with the coolant/refrigerant heat exchanger firstly have a common coolant-conducting connection to the air/coolant heat exchanger and secondly a common coolant-conducting connection to the valve system.

This nonprovisional application is a continuation of International Application No. PCT/EP2024/056675, which was filed on March 13, 2024, and which claims priority to German Patent Application No. 102023111091.8, which was filed in Germany on April 28, 2023, and which are both herein incorporated by reference.

### BACKGROUND OF THE INVENTION

### Field Of The Invention

The present invention relates to a coolant system for an electric or hybrid vehicle, and to a thermal management system for an electric or hybrid vehicle.

### Description of The Background Art

Coolant systems of this kind and thermal management systems for electric or hybrid vehicles are already known from the state of the art in numerous design variants. Known coolant systems for circulating a coolant for an electric or hybrid vehicle comprise a first coolant path with at least one first component to be cooled and/or to be heated, a second coolant path with at least one second component to be cooled and/or to be heated, a third coolant path with a coolant/refrigerant heat exchanger for the purpose of transmitting heat between the coolant system and a refrigerant system of the vehicle, an air/coolant heat exchanger for the purpose of transmitting heat between the coolant and ambient air in a free environment, and a valve system for realizing a plurality of coolant system states of the coolant system.

### SUMMARY OF THE INVENTION

It is therefore an object of the present invention to provide an improved coolant system for an electric or hybrid vehicle and a thermal management system for an electric or hybrid vehicle.

This object is achieved by a coolant system, which is characterized in that the first coolant path with the aforementioned first component and the third coolant path with the coolant/refrigerant heat exchanger firstly have a common coolant-conducting connection to the air/coolant heat exchanger and secondly a common coolant-conducting connection to the valve system. Further, this object is achieved by a thermal management system for an electric or hybrid vehicle.

A significant advantage of the coolant system of the invention for an electric or hybrid vehicle and of the thermal management system of the invention for an electric or hybrid vehicle is in particular that a coolant system for an electric or hybrid vehicle and a thermal management system for an electric or hybrid vehicle are improved. Due to the design of the coolant system according to the invention for an electric or hybrid vehicle and of the thermal management system for an electric or hybrid vehicle, an efficient coolant system for an electric or hybrid vehicle and an efficient thermal management system for electric or hybrid vehicles can be realized in a particularly simple manner in terms of design, production technology, and circuit technology. This applies in particular to the case that the thermal management system of the invention has a refrigerant system, therefore, a heat pump system, that is reduced to a necessary minimum.

The cooling system of the invention for an electric vehicle or hybrid vehicle and the thermal management system of the invention for an electric vehicle or hybrid vehicle are freely selectable within broad suitable limits in terms of type, mode of operation, material, and dimensioning.

The first component to be cooled and/or to be heated can be designed as a traction battery of the vehicle and/or that the second component to be cooled and/or to be heated is designed as a drivetrain of the vehicle, preferably that a coolant heater is arranged in the first coolant path and/or in the third coolant path in the direction of flow upstream of the traction battery and/or upstream of the coolant/refrigerant heat exchanger, particularly preferably that the coolant heater is designed as an electric auxiliary heater. This specifies in each case a component of the coolant system of the invention that is particularly suitable for the at least one first component and/or for the at least one second component. This has the further advantage that the first coolant path with the at least one first component and/or the third coolant path with the coolant/refrigerant heat exchanger can be additionally heated by means of the coolant heater. Further, this refinement specifies a coolant heater design that is particularly suitable for the technical task.

Like the at least one first component and the at least one second component, the coolant/refrigerant heat exchanger can also be freely selected within wide suitable limits. Expediently, the coolant/refrigerant heat exchanger is designed as a chiller. In this way, the coolant/refrigerant heat exchanger is designed to be particularly suitable for use in electric or hybrid vehicles, because a chiller is a special heat exchanger which is connected to both the coolant system and the refrigerant system of the electric or hybrid vehicle. This makes it possible to further reduce the temperature of the coolant through the refrigerant system. Additional indirect cooling, if necessary, for example, of the battery by the refrigerant system of the thermal management system of the invention can occur as a result.

The air/coolant heat exchanger can be designed as a front radiator of the vehicle. This further improves, for example, the cooling of the components to be cooled in the coolant system of the invention in a particularly simple and efficient manner.

The valve system can have only a single valve, this valve can be designed as a 7-way valve, particularly preferably as a 7/5-way valve. In this way, the valve system of the coolant system of the invention for an electric or hybrid vehicle is designed in a particularly advantageous manner in terms of design, production technology, and circuitry. With just a single valve on the coolant side, it is possible to create a large number of coolant system states that are necessary and useful for thermal management in an electric or hybrid vehicle. At the same time, the structural and thus cost-related effort in the realization of the coolant system of the invention is significantly reduced. This applies in particular to the example.

The common coolant-conducting connections can be designed as only a single fluidically continuous coolant line. The design and thus the structure of the coolant system of the invention for an electric or hybrid vehicle are thus simplified further and made more cost-effective as a result. This applies in particular to a design of the aforementioned coolant line that is free of valves or other shut-off fittings.

The coolant line can be connected in a coolant-conducting manner, upstream of the air/coolant heat exchanger, to the air/coolant heat exchanger and/or upstream of the at least one first component to be cooled and/or to be heated and/or downstream of the coolant/refrigerant heat exchanger. In this way, the aforementioned only single fluidically continuous coolant line is integrated into the overall structure of the coolant system of the invention in a fluidically particularly suitable manner.

Coolant can flow through the coolant line at least in sections in one or the other flow direction, depending on the coolant system state switched by means of the valve system. As a result, the aforementioned only single fluidically continuous coolant line can be used particularly flexibly, so that a plurality of coolant system states is made possible by means of the coolant system of the invention equipped with it in a simple manner in terms of design, production technology, and circuitry.

Further, the coolant system can additionally have at least one coolant tank for storing the coolant and for pressure equalization in the coolant system, preferably that the at least one coolant tank is designed as only a single coolant tank, particularly preferably that this coolant tank is arranged in the second coolant path upstream of a coolant pump arranged in the second coolant path in a coolant-conducting manner. In this way, the filling and storage of the coolant circulating in the coolant system of the invention, on the one hand, and the venting of the coolant system of the invention, on the other, are solved in a proven manner. This is made possible with only a single coolant tank by means of the example. Further, according to the example, this single coolant tank is arranged at a fluidically particularly suitable position in the coolant system of the invention.

The aforementioned designations of the individual components of the coolant system of the invention with consecutive numbers, such as, for example, the designation of the individual coolant paths as the first, second, and third coolant path, merely serves to easily distinguish the individual components of the coolant system of the invention from one another. It does not mean that a certain number of the named components must be present in accordance with the numbering used. For example, the existence of a fifth coolant system state in an example of the invention does not mean that a third or fourth coolant system state must necessarily exist as well.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of the coolant system of the invention of a thermal management system of the invention for an electric or hybrid vehicle in a process circuit diagram;

FIG. 2 shows the example in a representation analogous to FIG. 1 in a first coolant system state

FIG. 3 shows the example in a representation analogous to FIG. 1 in a second coolant system state;

FIG. 4 shows the example in a representation analogous to FIG. 1 in a third coolant system state;

FIG. 5 shows the example in a representation analogous to FIG. 1 in a fourth coolant system state; and

FIG. 6 shows the example in a representation analogous to FIG. 1 in a fifth coolant system state.

### DETAILED DESCRIPTION

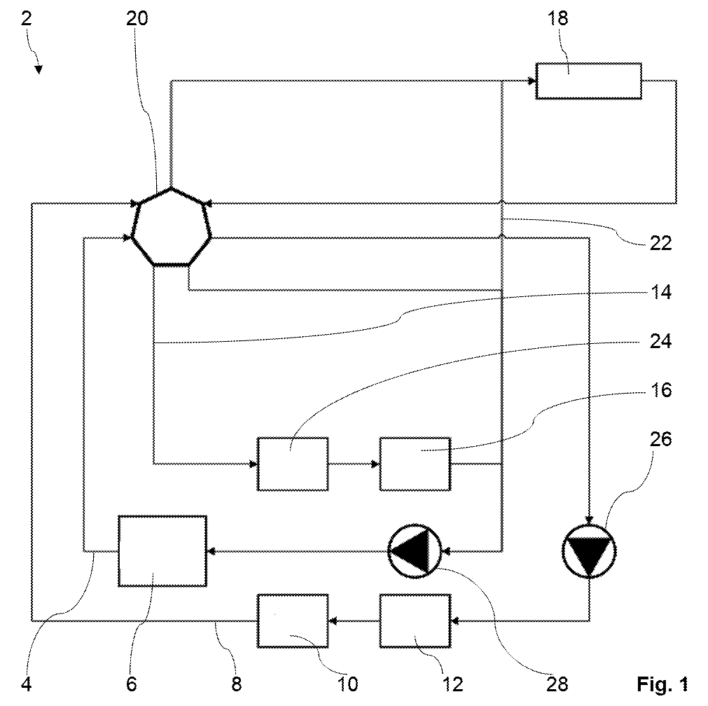

An example of the coolant system of the invention of a thermal management system of the invention for an electric or hybrid vehicle is described in FIGS. 1 to 6 purely by way of example. The rest of the thermal management system, namely, a refrigerant system designed to correspond to the coolant system, is not shown in more detail in FIGS. 1 to 6 and is designed, for example, in a manner known per se to the skilled artisan.

The coolant system 2 for circulating a coolant for an electric or hybrid vehicle comprises a first coolant path 4 with at least one first component 6 to be cooled and/or to be heated, a second coolant path 8 with at least one second component 10, 12 to be cooled and/or to be heated, a third coolant path 14 with a coolant/refrigerant heat exchanger 16 for the purpose of transmitting heat between coolant system 2 and the refrigerant system of the vehicle, an air/coolant heat exchanger 18 for the purpose of transmitting heat between the coolant and ambient air in a free environment, and a valve system 20 for realizing a plurality of coolant system states of coolant system 2. Due to the integration known per se of coolant system 2 into the thermal management system, superordinate to coolant system 2, with the refrigerant system designed to correspond to coolant system 2, a plurality of thermal management system states of the thermal management system can thus also be realized in a very simple manner in terms of design, production technology, and circuitry by means of the realization of the aforementioned plurality of coolant system states.

According to the invention, first coolant path 4 with the aforementioned first component 6 and third coolant path 14 with the coolant/refrigerant heat exchanger 16 firstly have a common coolant-conducting connection to the air/coolant heat exchanger 18 and secondly a common coolant-conducting connection to valve system 20, wherein the aforementioned common coolant-conducting connections in the example are designed as only a single fluidically continuous coolant line 22. Here, coolant line 22 is connected to air/coolant heat exchanger 18 in a coolant-conducting manner upstream of air/coolant heat exchanger 18 and upstream of first component 6 to be cooled and/or to be heated and downstream of coolant/refrigerant heat exchanger 16. In addition, depending on the coolant system state switched by means of valve system 20, coolant can flow through coolant line 22 at least in sections in one or the other flow direction. This will be explained in more detail below.

Further, first component 6 to be cooled and/or to be heated is designed as a traction battery of the vehicle and the second component to be cooled and/or to be heated is designed as a drivetrain of the vehicle with an electric drive motor 10 and corresponding power electronics 12. Moreover, a coolant heater 24 is arranged here in third coolant path 14 in the direction of flow upstream of coolant/refrigerant heat exchanger 16, wherein coolant heater 24 is designed as an electric auxiliary heater.

Coolant/refrigerant heat exchanger 16 is designed as a chiller, air/coolant heat exchanger 18 is designed as a front radiator of the vehicle, and valve system 20 is designed as a single valve, wherein the aforementioned valve 20 in the example is designed as a 7-way valve, namely, as a 7/5-way valve.

Coolant system 2 also has at least one coolant tank for storing the coolant and for pressure equalization in coolant system 2, wherein the at least one coolant tank in the example is designed as only a single coolant tank, namely, such that this coolant tank is arranged in second coolant path 8 upstream of a coolant pump 26 arranged in second coolant path 8 in a coolant-conducting manner. As can also be seen in FIG. 1, the drivetrain with drive motor 10 and power electronics 12 is arranged downstream of coolant pump 26. A coolant pump 28 is likewise arranged in first coolant path 4 upstream of traction battery 6. However, in other example of the invention, it is conceivable that the coolant pumps are arranged at least partially in other coolant paths of the coolant system of the invention, taking into account the required coolant system states. For example, coolant pump 28 could alternatively also be arranged in third coolant path 14 with chiller 16 to realize the coolant system states explained below.

In addition to the components already mentioned above, the thermal management system, namely, coolant system 2 with the refrigerant system of the thermal management system also has the following components: refrigerant/coolant heat exchanger, reservoir for the refrigerant, such as, for example, an accumulator or a receiver-drier, refrigerant compressor, and at least one valve. Further, the thermal management system can also have at least one bypass to at least one component of the coolant system, for example, an air/coolant heat exchanger.

The coolant lines are shown in FIGS. 1 to 6 using solid lines. Coolant lines through which coolant flows are shown with thick lines in FIGS. 1 to 6 in comparison to coolant lines through which coolant does not flow. In another example of the invention, in which coolant lines are routed in a bypass to one another in accordance with the aforementioned explanations, these coolant lines, which are routed in parallel in terms of flow technology, can, for example, be designed so that coolant can flow through them optionally and interdependently in a value range from 0% to 100%. As a result, according to this example, the valve system of the coolant system of the invention is designed on the coolant side particularly advantageously in an additional manner in terms of design, production technology, and circuitry, wherein the aforementioned flows can be adapted particularly well to the specific requirements. The aforementioned value range here means that either the entire coolant amount flows through the component or the bypass corresponding thereto or the coolant amount can be divided in a desired ratio between the coolant path with the aforementioned component and the bypass corresponding thereto.

The coolant system of the invention and the thermal management system of the invention according to the present example will be explained in more detail hereinbelow with reference to FIGS. 1 to 6.

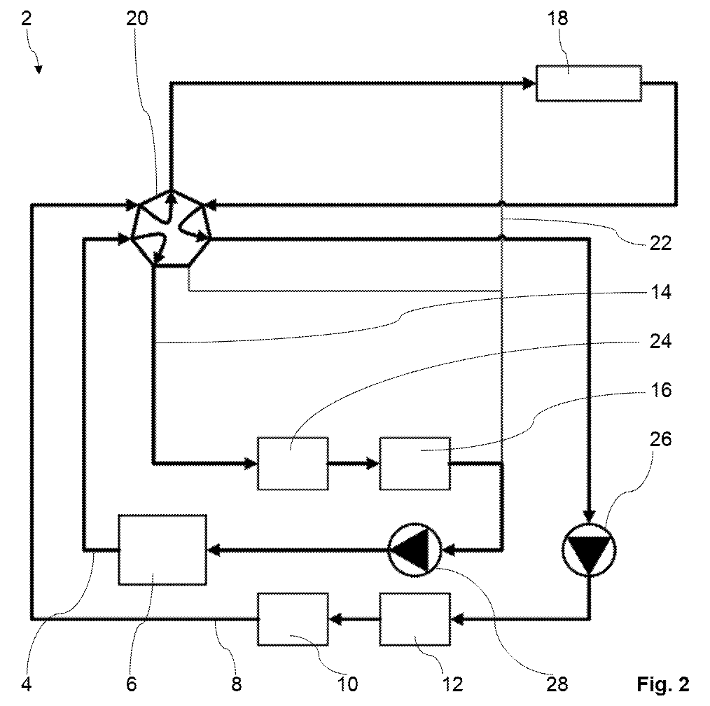

According to FIG. 2, first coolant path 4 is connected to traction battery 6 and third coolant path 14 is connected to chiller 16 in a coolant-conducting manner, so that traction battery 6 can be cooled by means of chiller 16. Parallel to this, front radiator 18 and second coolant path 8 are connected to the drivetrain, therefore, to drive motor 10 and power electronics 12, in a coolant-conducting manner, so that the drivetrain can be cooled by means of the ambient air. In the current switching state of valve 20, only a partial flow flows through coolant line 22. According to the invention, the wording used in the application text and the graphic representations firstly with regard to the respective flow of coolant through individual coolant paths and secondly with regard to a non-flow of coolant through individual coolant paths according to the invention means that coolant paths in the coolant system states corresponding thereto, for example, do not have a common coolant circulation. However, this includes example of the invention in which, for the purpose of filling and venting the coolant system by means of the at least one coolant tank, a connection suitable for the aforementioned purposes exists, irrespective of the respective switching state of the individual valves of the valve system.

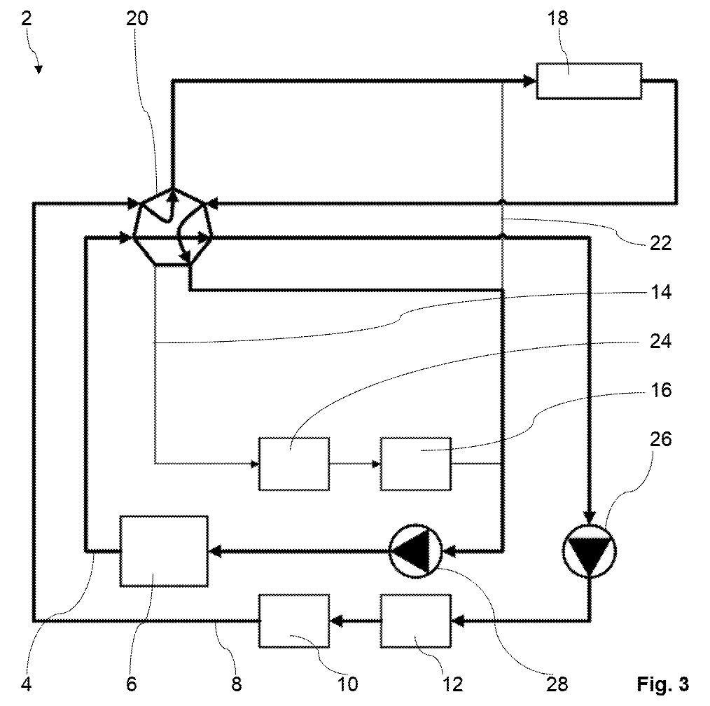

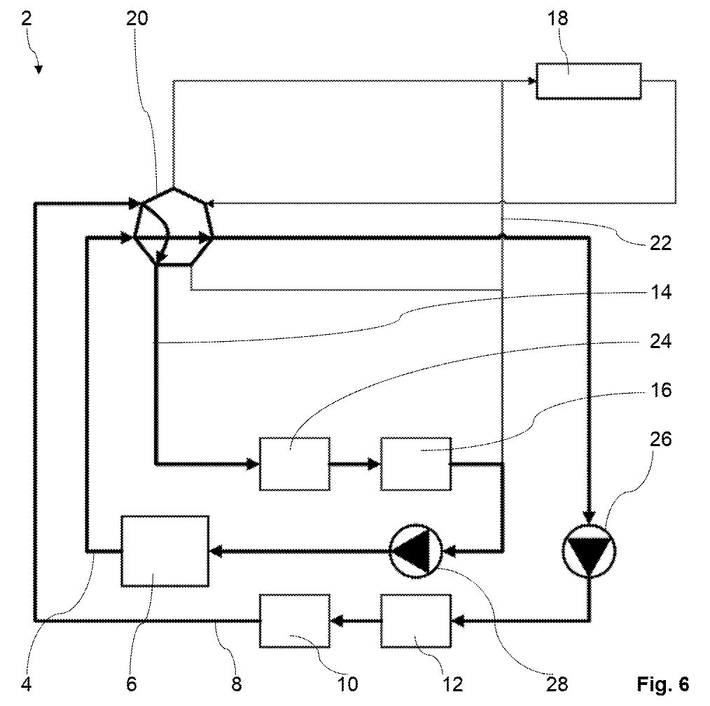

According to FIG. 3, front radiator 18, traction battery 6, and drivetrain 10, 12 are connected to form a common coolant circuit. Third coolant path 14 with chiller 16 is bypassed so that traction battery 6 is cooled by means of the ambient air, wherein drivetrain 10, 12 can be cooled subsequently by means of the coolant preheated by traction battery 6. Even in this switching state of valve 20, coolant flows only partially through coolant line 22. The crossing of flow paths through which coolant flows in valve 20 does not mean that these flow paths are connected to each other in a flow-conducting manner. This is not the case, here. The same also applies to the switching state shown in FIG. 6. Rather, this method of presentation is only used for the simplified graphic representation. In further examples of the invention, however, it may be provided that the at least one valve of the valve system comprises switching states in which flow paths in this valve are connected to one another in a flow-conducting manner.

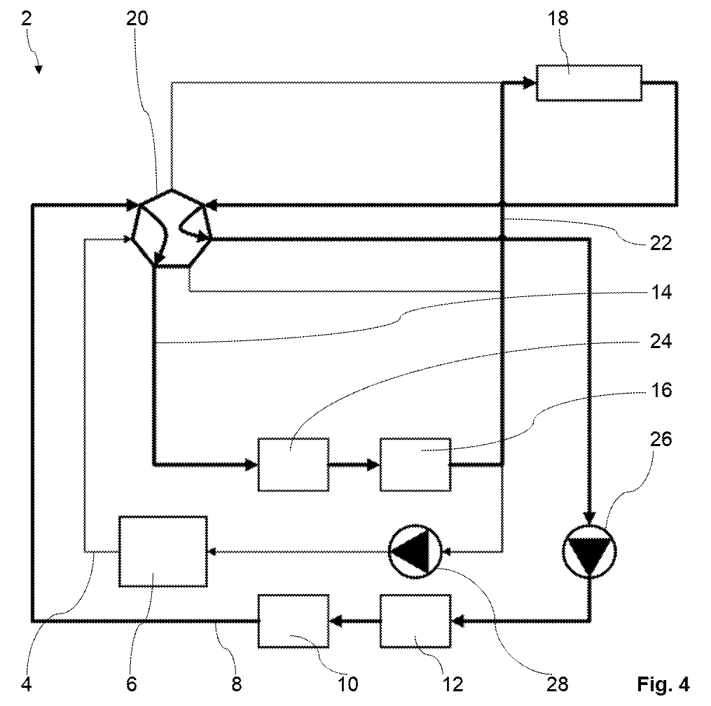

According to FIG. 4, chiller 16, front radiator 18, and drivetrain 10, 12 form a common coolant circuit. First coolant path 4 with traction battery 6 is bypassed in this case. The heat from the ambient air is first transferred to coolant system 2 and then from drivetrain 10, 12 to refrigerant system of the higher-level thermal management system by means of chiller 16 in a manner known to the skilled artisan. In the present switching state of valve 20, coolant firstly flows through coolant line 22 only partially and secondly in the opposite direction compared to FIGS. 2 and 3.

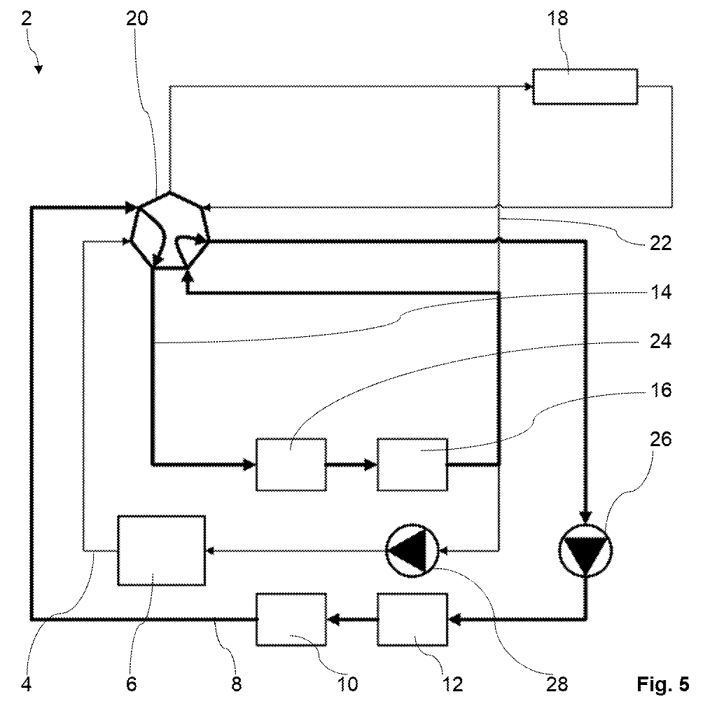

According to FIG. 5, second coolant path 8 with drivetrain 10, 12 and third coolant path 14 with chiller 16 form a common coolant circuit. Traction battery 6 and front radiator 18 are each bypassed. The heat from drivetrain 10, 12 is transferred to the refrigerant system by means of chiller 16. Here too, coolant flows only partially through coolant line 22 and in the same direction as in FIG. 4.

Further, FIG. 6 shows a switching state of valve 20, in which chiller 16, traction battery 6, and drivetrain 10, 12 form a common coolant circuit. Front radiator 18 is bypassed in this case. Traction battery 6 is heated hereby using the waste heat from drivetrain 10, 12. Optionally, this can be supported by electric auxiliary heater 24. The flow through coolant line 22 presented here corresponds to that in FIG. 2.

As can be seen from the above explanations, the individual FIGS. 1 to 6, with the coolant‑side switching state of valve 20 shown therein in each case, each correspond to at least one coolant system state of coolant system 2.

Due to the design of coolant system 2 according to the invention for an electric or hybrid vehicle and of the thermal management system for an electric or hybrid vehicle, an efficient coolant system 2 for an electric or hybrid vehicle and an efficient thermal management system for an electric or hybrid vehicle can be realized in a particularly simple manner in terms of design, production technology, and circuitry. This applies in particular to the present case where the thermal management system has a refrigerant system, therefore, a heat pump system, that is reduced to the required minimum.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A coolant system for circulating a coolant for an electric or hybrid vehicle, the coolant system comprising:
a first coolant path with at least one first component to be cooled and/or to be heated;
a second coolant path with at least one second component to be cooled and/or to be heated;
a third coolant path with a coolant/refrigerant heat exchanger to transmit heat between the coolant system and a refrigerant system of the vehicle;
an air/coolant heat exchanger to transmit heat between the coolant and ambient air in a free environment; and
a valve system to realize at least two coolant system states of the coolant system,
wherein the first coolant path with the first component and the third coolant path with the coolant/refrigerant heat exchanger have a common coolant-conducting connection to the air/coolant heat exchanger and have a common coolant-conducting connection to the valve system.

2. The coolant system according to claim 1, wherein the first component to be cooled and/or to be heated is a traction battery of the vehicle, and/or wherein the second component to be cooled and/or to be heated is a drivetrain of the vehicle, wherein a coolant heater is arranged in the first coolant path and/or in the third coolant path in a direction of flow upstream of the traction battery and/or upstream of the coolant/refrigerant heat exchanger, or wherein the coolant heater is an electric auxiliary heater.

3. The coolant system according to claim 1, wherein the coolant/refrigerant heat exchanger is a chiller.

4. The coolant system according to claim 1, wherein the air/coolant heat exchanger is a front radiator of the vehicle.

5. The coolant system according to claim 1, wherein the valve system has only a single valve, or wherein the valve is a 7-way valve or a 7/5-way valve.

6. The coolant system according to claim 1, wherein the common coolant-conducting connections are designed as only a single fluidically continuous coolant line.

7. The coolant system according to claim 6, wherein the coolant line is connected in a coolant-conducting manner, upstream of the air/coolant heat exchanger, to the air/coolant heat exchanger and/or upstream of the at least one first component to be cooled and/or to be heated and/or downstream of the coolant/refrigerant heat exchanger.

8. The coolant system according to claim 6, wherein coolant flows through the coolant line at least in sections in one or the other flow direction, depending on the coolant system state switched via the valve system.

9. The coolant system according to claim 1, wherein the coolant system additionally has at least one coolant tank for storing the coolant and for pressure equalization in the coolant system, wherein the at least one coolant tank is a single coolant tank, or wherein the coolant tank is arranged in the second coolant path upstream of a coolant pump arranged in the second coolant path in a coolant-conducting manner.

10. A thermal management system for an electric or hybrid vehicle, the thermal management system comprising:
the coolant system according to claim 1, to circulate a coolant; and
a refrigerant system to circulate a refrigerant.
